(19) United States
(12) Patent Application Publication
(10) Pub. No.: US 2006/0085834 A1
(43) Pub. Date: Apr. 20, 2006

(54) System and method for transmitting multi-channel signals

(75) Inventors: Shao-Ning Chang, Taipei (TW); Che-Ming Chi, Taipei (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Cayin Technology Co., Ltd.

(21) Appl. No.: 10/968,419

(22) Filed: Oct. 19, 2004

(51) Int. Cl. H04N 7/173

(52) U.S. Cl. 725/115; 725/114; 725/116; 725/119

(57) ABSTRACT

The present invention disclosed a system and method for transmitting multi-channel signals. With this system and method, each user can watch all available DTV channels without an exclusive antenna and tuner. The UDP port numbers are applied as the virtual channels to be selected by users, and decreasing the number of required antennas and tuners also decrease cost. The system comprises a plurality of audio/video sources for providing audio/video content and a server. A hub is coupled to the server, and a plurality of display units is coupled to the hub, whereas each of the display units receives the audio/video signals and displays the audio/video content from at least one of the audio/video sources.

### FIELD OF THE INVENTION

The present invention is related to a system for transmitting multi-channel signals, especially to a system for transmitting multi-channel signals with a unique network port for each channel.

### BACKGROUND OF THE INVENTION

Digital television (DTV) has gained increasing popularity in the recent period. In the analog world, all communication media has a certain frequency, and exclusive channels were required for transmission. However, new technological breakthroughs in the digital world have allowed media to overlap. Data, sound and video signals are all reduced to the same binary code, and can be transmitted by a variety of devices over many areas of the spectrum. In addition, information can be transmitted more efficiently. Since the transmission of DTV signals is pretty reliable relative to that of traditional TV signals, it is possible to receive and watch high quality DTV in a motor vehicle moving in high speed.

Analog or traditional TV sets receive radio signals through the airwaves or electrical signals via cable. The signals transmitted by radio wave are displayed by the degree of color brightness for each particular pixel on the TV screen. Digital TV sets also receive electrical signals, but signals represent either a “digital zero” or a “digital one”. A decoder then turns this digital stream into patterns of pixels on the screen. Therefore, a tuner and an antenna are required to watch DTV with multi-channel.

It is tedious to travel long hours either by bus, train, boat, and sometimes even by airplane, so the proprietors have provided some entertainments for passengers, such as video games or VCD players. Since the content of these entertainments is usually invariable and out-of-date, the application of DTV may solve such a problem. With the advent of a DTV system, passengers could watch real-time TV programs, and the proprietors pay nothing for the automatically updated content.

Although a DTV system has many benefits, the disadvantage of a DTV system is that each seat should be equipped with an antenna for receiving DTV signals and a tuner for selecting desired channels. In other words, suppose a bus could seat thirty, then thirty antennas and thirty tuners are needed for passengers to watch DTV with multi-channel. As a result, the cost of providing such equipments remains fairly high.

In brief, in order to provide multi-channel DTV programs in the mass transit, an efficient and inexpensive system should be disclosed.

### SUMMARY OF THE INVENTION

Given the current problem faced with high cost, the present invention provides a system and method for transmitting multi-channel signals. With this new system and method, fewer antennas and tuners are required in transportation vehicles with plenty of seats. Therefore, the cost of the DTV system would decline.

One aspect of this new invention discloses a system for transmitting multi-channel signals and comprises a plurality of audio/video sources for providing audio/video content. A server is coupled to the audio/video sources for assigning one of network port indexes to each of the audio/video sources, and generates the audio/video signals based on the audio/video content, thereby transmitting the signals. A hub is coupled to the server and a plurality of display units is coupled to this hub, wherein each of these display units receives the audio/video signals and displays the audio/video content from at least one of the sources. The audio/video sources may be a plurality of DTV receivers, and the network port index may be UDP port number or TCP port number. In addition, the display units may include a liquid crystal display (LCD), a cathode ray tube (CRT) display, a plasma display panel (PDP), a light emitting diode (LED) display, an organic light emitting diode (OLED) display, a projector, a speaker, an earphone, a headphone, or a device which can present information in visual/acoustic form. With such system, an end user is able to choose a specific “channel” by selecting a corresponding network port index via one of the display units, and this “channel” substantially represents certain audio/video source.

Another aspect of the present invention discloses a method for transmitting multi-channel signals. This method may comprise steps of receiving audio/video content from a plurality of audio/video sources. Next, one of the network port indexes is assigned to each of the audio/video sources, and the signals are generated on the basis of the audio/video content. The signals contain information corresponding to the network port indexes. After that, the audio/video signals are transmitted to a plurality of display units. Finally, at least one of the audio/video sources is displayed on at least one of the display units. Similar to the above system, the audio/video sources may be a plurality of DTV receivers, and the network port index may be UDP port number or TCP port number. Besides, the display units may include a liquid crystal display (LCD), a cathode ray tube (CRT) display, a plasma display panel (PDP), or a projector. An end user is able to choose a specific “channel” by selecting a corresponding network port index via one of the display units, and this “channel” substantially represents certain audio/video source.

### BRIEF DESCRIPTION OF THE DRAWINGS

FIG. 1 is a block diagram of the present invention.

FIG. 2 is a flow chart of the present invention.

### DETAILED DESCRIPTION OF THE PREFERRED EMBODIMENT

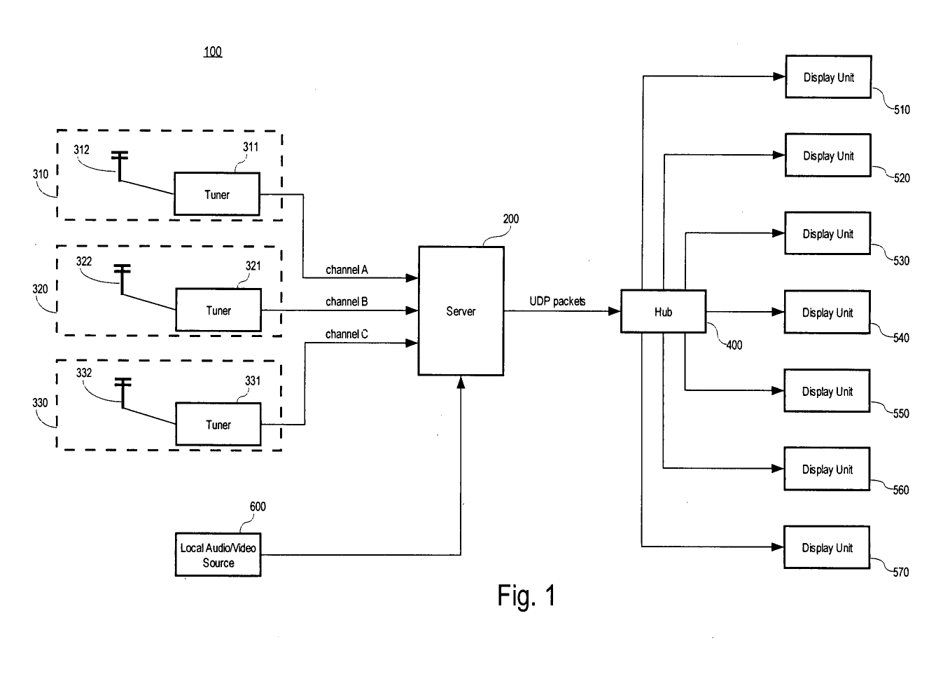

FIG. 1 shows the system 100 which is one embodiment of the present invention. The system 100 is introduced to transmit DTV signals and local audio/video source to end users. To receive DTV signals, the system 100 includes a plurality of, for example, three receivers 310, 320, and 330 as audio/video sources. Each of these receivers include a tuner (311, 321, or 331) and an antenna (312, 322, or 332), respectively. In our figure, the number of the receivers is cited merely for illustration instead of limitation, and the present invention would encompass any number of the receivers (including one). In another aspect of the present invention, receivers may share the same antennas or the same tuners; that is, the number of antennas or tuners would be less than the receivers. Although each of the receivers 310, 320, and 330 possess an exclusive tuner and antenna in the preferred embodiment shown in FIG. 1, fewer tuners and antennas could be used in other embodiments of the present invention. In addition, these receivers may also receive audio/video signals other than DTV signals, including FM audio signals or conventional (analog) TV signals.

In this embodiment, each of the receivers 310, 320, and 330 is predetermined to pass a certain DTV channel. In other words, the antennas 312, 322, 332 receive the same DTV signals, yet each of the tuners 311, 321, 331 is set to a fixed DTV channel. For example, the tuner 311 is set to channel A, the tuner 321 is set to channel B, and the tuner 331 is set to channel C, provided that the channels A, B, and C are different from each other, and the channels of these receivers are still changeable. Next, the three receivers feed the audio/video content with specific channels into a server 200. The major work of the server 200 is to assign a network port index to each of the audio/video sources, i.e., the DTV receivers. The UDP port number is applied as the network port index. However, the types of the network port index are variable, such as the TCP port number, and the present invention would encompass any possible port index provided by various network protocols.

In this embodiment, the UDP port 1 is assigned to the receiver 310, the UDP port 2 is assigned to the receiver 320, and the UDP port 3 is assigned to the receiver 330, respectively. The above example is cited for illustration instead of limitation. Next, the sever 200 would generate audio/video signals based on the audio/video content of the receivers 310, 320, 330 after the reception of the content. The audio/video signals preferably contain the above mentioned presentation. In other words, the audio/video signals may include a mapping table recording the relationship between the DTV receivers and the UDP port numbers. The audio/video signals with mapping table would be transferred to a plurality of display units 510-570 via a hub 400.

Moreover, the system 100 may further comprise a local audio/video source 600, such as a VCD player, a DVD player, a VHS player, or a hard disc with a video file stored therein. The audio/video content of such local audio/video source 600 is also fed to the server 200, and the server 200 would assign a UDP port number, UDP port 4 for example, to the local audio/video source 600. In addition, the audio/video signals and the mapping table should also contain relative data of the local audio/video source. Besides, other types of the audio/video sources could also be utilized in the present invention, such as a radio, a cassette player, a tape player, wired/wireless LAN with audio/video content, wired/wireless WAN with audio/video content, a webcam, a video camera, a digital still camera, a digital video camera, a microphone, a CD/DVD ROM, a hard disk, a floppy disk, a flash memory storage device, a ZIP drive, a SCSI storage device, an IEEE 1394 storage device, a USB storage device, a tuner, an A/D converter, a D/A converter, or a device/means which can store, generate, convert, transfer, or transmit audio/video signals/files.

Since the video from the audio/video sources may be transferred as analog signals, the server 200 may have to convert them into digital signals. Besides, the audio/video content might be abundant, so the corresponding audio/video signals would be tremendous in file size. Therefore, the server 200 may also compress the audio/video signals before transmit them. The signal conversion and compression technologies are well known to the ordinary people skilled in the art, so the description of signal compression is omitted to prevent from obscuring the present invention.

The compressed audio/video signals are subsequently transferred in form of UDP packets or TCP packets to the display units. In FIG. 1, there are seven display units 510-570. The number of the display units is cited merely for illustration, not to limit the scope of the present invention. Any possible number of the display units, even up to hundreds, could be included in the present invention. The hub 400 is preferably a switch hub, and the other types of equivalent device may also be applied, such as a router, a wireless access point, or a gateway. In the embodiment, the server 200, the display units 510-570 are coupled to the hub via RJ-45 cables. Other ways of coupling may also be adopted, such as WiFi or Bluetooth wireless transmission.

The system 100 may be built in a mass transportation tool, for example, bus, train, ship and airplane. In such situation, the display units 510-570 would be the personal entertaining devices installed and adapted to their seats. Preferably, the number of the display units is exactly the same as that of the seats.

Next, the operation of display unit 510 is taken for example, and the operation of remaining display units 520-570 is similar and omitted.

The display unit 510 could receive all audio/video signals from the server 200 via the hub 400. The display unit 510 may provide some control means, such as a keypad, for a user. The user is able to select specific UDP port number and let the display unit 510 display the audio/video content of the corresponding audio/video source. For example, if the user selects UDP port 2, then the display unit 510 would display the audio/video content of the receiver 320. Similarly, if the UDP port 4 is selected, the audio/video content of the local audio/video source 600 would be displayed.

It is noted that although the user substantially select certain UDP port number, he/her may select a channel to watch, even without an actual tuner. The proprietor can choose a few DTV channels to provide, and the cost would be limited to the number of selected DTV channels. In other words, if the number of the provided DTV channels is smaller than that of the seats, the cost would be less and also saves space because fewer tuners and antennas are required. Generally, the number of selected DTV channels plus that of local video device is far fewer than that of the seats. As we know, if the bus has tens of seats, yet there are usually fewer than ten selected DTV channels. Furthermore, this system could also apply to a boat, a train, an airplane, or even in a building. In these situations, the required display units are always much more than the DTV channels. Hence, the system of the present invention is economical and lowers the overall cost. Other benefits of this new invention include the less complicated cabling works, easy installation, and are overall more efficient.

Furthermore, the display unit may include a liquid crystal display (LCD), a cathode ray tube (CRT) display, a plasma display panel (PDP), a light emitting diode (LED) display, an organic light emitting diode (OLED) display, a projector, a speaker, an earphone, a headphone, or a device which can present information in visual/acoustic form. The types of display unit are cited merely for illustration, not for limitation.

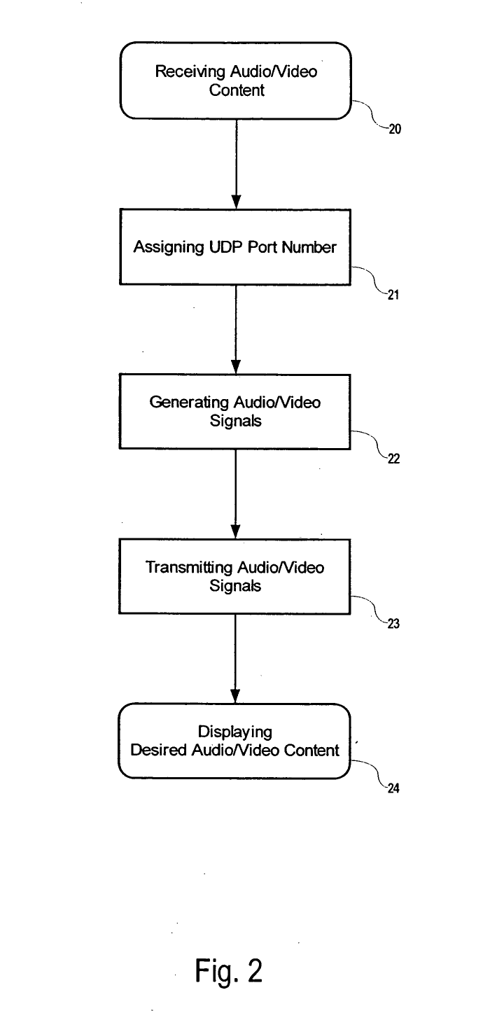

FIG. 2 shows a flow chart of the present invention, which discloses a method for transmitting multi-channel signals. In step 20, the audio/video content is first received from a few audio/video sources. The audio/video sources may include DTV receivers or local audio/video source as mentioned above, and are respectively assigned an exclusive UDP port number in step 21. In another embodiment of the present invention, the other network port indexes, such as TCP port numbers, might be used to replace the UDP port numbers. Still, a server is preferably applied to the process of designation. Next, the audio/video signals are generated by the server based on the audio/video content in step 22. The generated audio/video signals contain the assigned information corresponding to the UDP port numbers. In one embodiment of the present invention, the audio/video signals are also converted and/or compressed by the server. After generated and even compressed, the audio/video signals are transmitted to display units via a hub in step 23. The server and the display units are connected via a hub, and such hub may include a switch hub, a router, a wireless access point, or a gateway. Moreover, the server, the display units, and the hub may be coupled via the RJ-45 cables or even wireless or Bluetooth connection.

Similar to the foregoing display units in system 100, these display units may comprise various types of display means, such as a liquid crystal display (LCD), a cathode ray tube (CRT) display, a plasma display panel (PDP), a light emitting diode (LED) display, an organic light emitting diode (OLED) display, a projector, a speaker, an earphone, a headphone, or a device which can present information in visual/acoustic form. In step 24, audio/video content of the desired audio/video source is displayed on at least one of the display units. In other words, the user may select certain UDP port number via a display unit, and the corresponding audio/video content would be displayed. Therefore, even without a tuner, the user is still able to choose “channels.”

With this method, the required number of tuners and antennas would be the same as that of the provided channels, and much fewer than that of the display units, i.e., the seats. Thus, the cost, time, and space required for receiving and transmitting multi-channel DTV signals in an environment with plenty of display units are declined to an economical and efficient level.

In addition, the above system or method can also be seen in a variety of situations including buildings or a community. For example, if there are fifty resident families in an apartment complex and twenty available DTV channels, at least fifty antennas and tuners are required for every family to receive all DTV channels. With this new invention, only twenty antennas and tuners are required. As a result, the present invention is still economical even when applied to other situations.

The present invention is intended to cover various modifications and similar arrangements included within the spirit and scope of the appended claims. The scope should be accorded to the broadest interpretation as to encompass all such modifications and similar structure. Various changes can be made without departing from the spirit and scope of the invention.

We claim:

1. A system for transmitting audio/video signals, which comprises:
a plurality of audio/video sources for providing audio/video content;
a server coupled to said plurality of audio/video sources for assigning one of network port indexes to each of said plurality of audio/video sources, and generating said audio/video signals based on said audio/video content, thereafter transmitting said audio/video signals;
a hub coupled to said server; and
a plurality of display units coupled to said hub, wherein each of said plurality of display units receives said audio/video signals and displays said audio/video content from at least one of said plurality of audio/video sources.

2. The system as set forth in claim 1, wherein said plurality of audio/video sources include a plurality of DTV (digital television) receivers, and said plurality of digital television receivers has at least one antenna and at least one tuner for receiving a DTV channel.

3. The system as set forth in claim 1, wherein said plurality of audio/video sources include a radio, a cassette player, a tape player, a VCD player, a DVD player, a VHS player, wired/wireless LAN with audio/video content, wired/wireless WAN with audio/video content, a webcam, a video camera, a digital still camera, a digital video camera, a microphone, a CD/DVD ROM, a hard disk, a floppy disk, a flash memory storage device, a ZIP drive, a SCSI storage device, an IEEE 1394 storage device, a USB storage device, a tuner, an A/D converter, a D/A converter, or a device/means which can store, generate, convert, transfer, or transmit audio/video signals/files.

4. The system as set forth in claim 1, wherein said hub is a switch hub, a router, a wireless access point, or a gateway.

5. The system as set forth in claim 1, wherein said network port indexes include numbers of UDP (User Datagram Protocol) ports or numbers of TCP (Transmission Control Protocol) ports.

6. The system as set forth in claim 1, wherein said audio/video signals are transferred in the form of UDP packets or TCP packets.

7. The system as set forth in claim 1, wherein said server compresses said audio/video signals before said audio/video signals are transmitted.

8. The system as set forth in claim 1, wherein said server converts said audio/video signals into digital signals.

9. The system as set forth in claim 1, wherein said plurality of display units include a liquid crystal display (LCD), a cathode ray tube (CRT) display, a plasma display panel (PDP), a light emitting diode (LED) display, an organic light emitting diode (OLED) display, a projector, a speaker, an earphone, a headphone, or a device which can present information in visual/acoustic form.

10. The system as set forth in claim 1, wherein said audio/video content from at least one of said plurality of audio/video sources is displayed by selecting at least one of said network port indexes via at least one of said plurality of display units.

11. A method for transmitting audio/video signals, which comprises:
receiving audio/video content from a plurality of audio/video sources;
assigning one of network port indexes to each of said audio/video sources;
generating said audio/video signals based on said audio/video content, wherein said audio/video signals contain assignation information corresponding to said network port indexes;
transmitting said audio/video signals to a plurality of display units; and
displaying said audio/video content from at least one of said plurality of audio/video sources on at least one of said display units.

12. The method as set forth in claim 11, which further comprises:
compressing said audio/video signals before transmitting said audio/video signals.

13. The method as set forth in claim 11, which further comprises:
converting said audio/video signals into digital signals if said audio/video signals are analog signals.

14. The method as set forth in claim 11, wherein a server is used to assign said network port indexes, and generate and compress/convert said audio/video signals, thereafter transmit said audio/video signals.

15. The method as set forth in claim 14, wherein said server are coupled to said plurality of display units via a hub, which is a switch hub, a router, a wireless access point, or a gateway.

16. The method as set forth in claim 11, wherein said plurality of audio/video sources include a plurality of DTV (digital television) receivers for receiving DTV channels.

17. The method as set forth in claim 11, wherein said plurality of audio/video sources include a radio, a cassette player, a tape player, a VCD player, a DVD player, a VHS player, wired/wireless LAN with audio/video content, wired/wireless WAN with audio/video content, a webcam, a video camera, a digital still camera, a digital video camera, a microphone, a CD/DVD ROM, a hard disk, a floppy disk, a flash memory storage device, a ZIP drive, a SCSI storage device, an IEEE 1394 storage device, a USB storage device, a tuner, an A/D converter, a D/A converter, or a device/means which can store, generate, convert, transfer, or transmit audio/video signals/files.

18. The method as set forth in claim 11, wherein said network port indexes include numbers of UDP (User Datagram Protocol) ports or numbers of TCP (Transmission Control Protocol) ports.

19. The method as set forth in claim 11, wherein said audio/video signals are transferred in the form of UDP packets or TCP packets.

20. The method as set forth in claim 11, wherein said plurality of display units include a liquid crystal display (LCD), a cathode ray tube (CRT) display, a plasma display panel (PDP), a light emitting diode (LED) display, an organic light emitting diode (OLED) display, a projector, a speaker, an earphone, a headphone, or a device which can present information in visual/acoustic form.

21. The method as set forth in claim 11, wherein said audio/video content from at least one of said plurality of audio/video sources is displayed by selecting at least one of said network port indexes via at least one of said plurality of display units.
